(19) United States
(12) Patent Application Publication
(10) Pub. No.: US 2009/0309937 A1
(43) Pub. Date: Dec. 17, 2009

(54) INK STORAGE MODULE CAPABLE OF CONTROLLING FLOW OF INK AND RELATED PRINTING SYSTEM

(76) Inventors: Shr-How Huang, Taipei City (TW); Tsung-Chi Hung, Taipei County (TW); Cheng-Lin Tsai, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/422,986

(22) Filed: Apr. 13, 2009

(30) Foreign Application Priority Data
Jun. 17, 2008 (TW) 097122509

(51) Int. Cl. B41J 2/175

(52) U.S. Cl. 347/85

(57) ABSTRACT

An ink storage module includes an ink flow control device and an air chamber. The ink storage module is accessible to an ink tank and an air-extracting device. The ink flow control device includes an ink storage chamber and a pressure control mechanism. The ink storage chamber is used for receiving and storing ink conveyed from the ink tank. The pressure control mechanism is connected to the ink storage chamber for controlling the connection of an external pressure to the ink storage chamber. The air chamber is disposed at a side of the ink flow control device and is accessible to the ink storage chamber. The air chamber is used for exhausting air extracted by the air-extracting device. When the pressure control mechanism controls the ink storage chamber to cut off the external pressure, the air-extracting device drives ink to flow from the ink tank to the ink storage chamber.

### BACKGROUND OF THE INVENTION

1. Field of the Invention

The present invention relates to an ink storage module and a related printing system, and more specifically, to an ink storage module capable of controlling flow of ink and a related printing system.

2. Description of the Prior Art

A common ink absorbing device in a printing apparatus usually disposes a print head reservoir and an ink tank separately for reducing volume of a holding device for holding the print head reservoir, and utilizes an ink pipe to connect the ink tank and an ink storage chamber above a print head for ink conveyance. Furthermore, the said ink absorbing device utilizes a pump to pump ink from the ink tank to the ink storage chamber via the ink pipe.

Related ink conveyance methods are mainly divided into two types. One type involves disposing a linkage mechanism including pins and a cam between each ink storage space and a pump. However, this method may require a delicate linkage mechanism design. That is to say, tolerances between each pin and the cam need to be very tight, or ink may leak.

Another type of ink conveyance involves conveying all colors of ink into the ink storage chamber at one time. The ink storage chamber is designed to have greater volume than the ink tank.

### SUMMARY OF THE INVENTION

The present invention provides an ink storage module capable of controlling flow of ink from an ink tank to the ink storage module, the ink storage module comprising an ink flow control device comprising an ink storage chamber connected to the ink tank via an ink inlet, the ink storage chamber used for receiving and storing ink conveyed from the ink tank through the ink inlet; and a pressure control mechanism connected to the ink storage chamber for controlling the connection of an external pressure to the ink storage chamber; and an air chamber disposed at a side of the ink flow control device and accessible to the ink storage chamber for exhausting air extracted by the air-extracting device, the air-extracting device driving ink to flow from the ink tank to the ink storage chamber when the pressure control mechanism controls the ink storage chamber to cut off the external pressure.

The present invention further provides a printing system capable of controlling flow of ink, the printing system comprising an ink tank; an air-extracting device for driving ink stored in the ink tank; and an ink storage module connected to the ink tank and the air-extracting device, the ink storage module comprising an ink flow control device comprising an ink storage chamber connected to the ink tank via an ink inlet, the ink storage chamber used for receiving and storing the ink conveyed from the ink tank through the ink inlet; and a pressure control mechanism connected to the ink storage chamber for controlling the connection of an external pressure to the ink storage chamber; and an air chamber disposed at a side of the ink flow control device and accessible to the ink storage chamber for exhausting air extracted by the air-extracting device, the air-extracting device driving ink to flow from the ink tank to the ink storage chamber when the pressure control mechanism controls the ink storage chamber to cut off the external pressure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a printing system according to a preferred embodiment of the present invention.

FIG. 2 is a schematic diagram of the printing system in FIG. 1.

FIG. 3 is a diagram of an inner structure in an ink storage module in FIG. 1.

FIG. 4 is an enlarged diagram of a pressure control mechanism in FIG. 3.

FIG. 5 is an exploded diagram of the pressure control mechanism in FIG. 4.

FIG. 6 is a schematic diagram of a maintenance module in FIG. 1.

FIG. 7 is a diagram of an inner structure of the printing system in FIG. 1.

FIG. 8 is a diagram showing that an air valve in FIG. 3 is moved to the communication location of an ink storage chamber and an external pressure.

FIG. 9 is a diagram of a pressure control mechanism according to another preferred embodiment of the present invention.

FIG. 10 is a diagram of a pressure control mechanism according to another preferred embodiment of the present invention.

### DETAILED DESCRIPTION

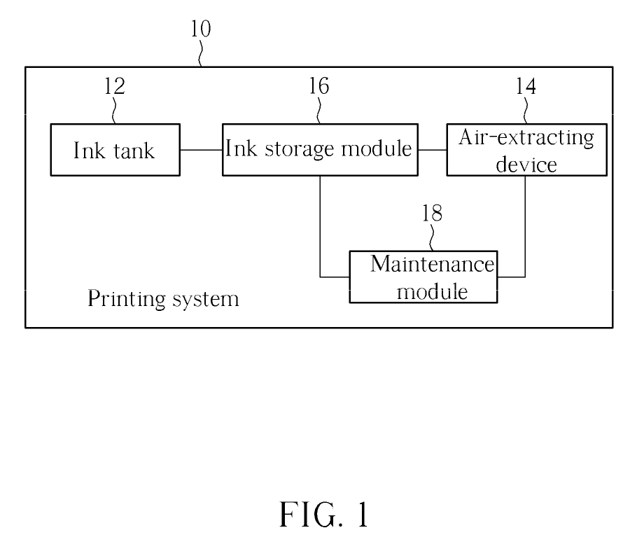

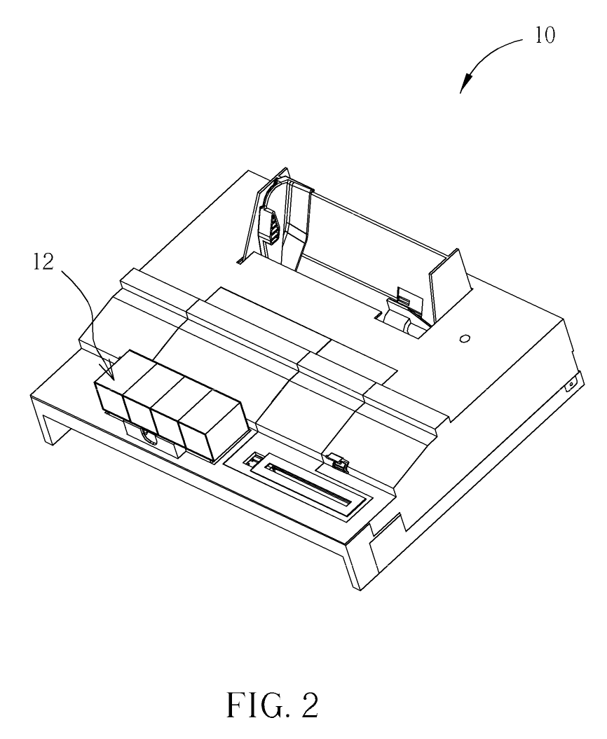

Please refer to FIG. 1. FIG. 1 is a functional block diagram of a printing system 10 according to a preferred embodiment of the present invention. As shown in FIG. 1, the printing system 10 comprises at least one ink tank 12, an air-extracting device 14, an ink storage module 16 and a maintenance module 18. The ink tank 12 is used for storing ink. The air-extracting device 14 is used for driving the ink stored in the ink tank 12. In one embodiment of the present invention, the air-extracting device 14 may be a pump. The ink storage module 16 is connected to the ink tank 12 and the air-extracting device 14. The ink storage module 16 is used for storing the ink conveyed from the ink tank 12. Further, refer to FIG. 2. A plurality of ink tanks 12 may be disposed in the printing system 10 (four shown in FIG. 2) for respectively storing different colors of ink.

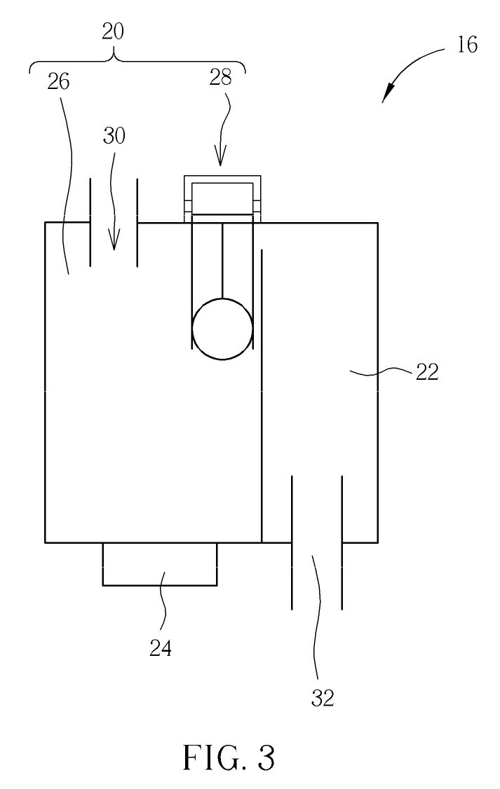

In FIG. 3, the ink storage module 16 comprises an ink flow control device 20, an air chamber 22, and a print head 24. The ink flow control device 20 comprises an ink storage chamber 26 and a pressure control mechanism 28. The ink storage chamber 26 has an ink inlet 30. Ink flows through the ink inlet 30 from the ink tank 12 via an ink pipe (not shown). The ink storage chamber 26 is used for receiving and storing the ink conveyed through the ink inlet 30. The pressure control mechanism 28 is connected to the ink storage chamber 26 for controlling the connection of an external pressure to the ink storage chamber 26. The air chamber 22 is disposed at a side of the ink flow control device 20 and is accessible to the ink storage chamber 26. The air chamber 22 has an air outlet 32 for exhausting air extracted by the air-extracting device 14. When the pressure control mechanism 28 controls the ink storage chamber 26 to cut off the external pressure, the air-extracting device 14 drives the ink to flow from the ink tank 12 to the ink storage chamber 26 through the ink inlet 30. The print head 24 is used for receiving and storing the ink conveyed from the ink storage chamber 26 of the ink flow control device 20. Furthermore, since the ink storage module 16 may be used for storing the ink conveyed from the ink tank 12, and the plurality of ink tanks 12 may be disposed in the printing system 10, the number of the ink storage modules 16 may correspond to the number of the ink tanks 12 disposed in the printing system 10, meaning that the number of the ink storage modules 16 may be equal to the number of the ink tanks 12. The ink storage chamber 26 of each ink flow control device 20 is thereby accessible to the air chamber 22, respectively. Since all have the same structural design, only one of the ink flow control devices 20 is described as follows.

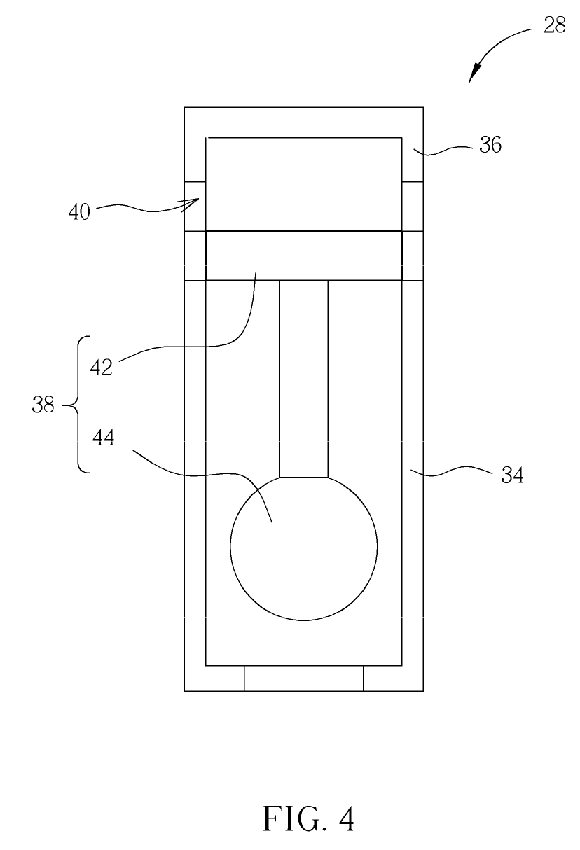

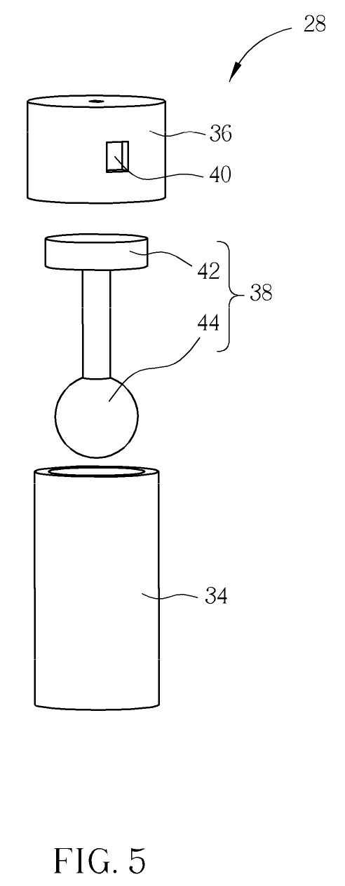

FIG. 4 is an enlarged diagram of the pressure control mechanism 28 in FIG. 3. As shown in FIG. 4, the pressure control mechanism 28 of the ink flow control device 20 comprises a vent channel 34, an upper lid 36, and an air valve 38. The upper lid 36 is connected to the vent channel 34. Here, the upper lid 36 can be connected to the vent channel 34 in a detachable manner or can be connected to the vent channel 34 monolithically. The upper lid 36 has at least one hole 40 for exposing the ink storage chamber 26 to the external pressure. The air valve 38 is disposed in the vent channel 34 and the upper lid 36 in a movable manner. The air valve 38 comprises a valve lid 42 and a float 44. Please refer to FIG. 5, which is an exploded diagram of the pressure control mechanism 28 in FIG. 4. As shown in FIG. 5, the valve lid 42 is a round plate. The valve lid 42 is made of flexible material, such as rubber. The valve lid 42 is used for sealing the vent channel 34 to isolate the ink storage chamber 26 from the external pressure. That is, the upper lid 36 and the valve lid 42 are fit for isolating the ink storage chamber 26 from the external pressure. The float 44 is a spherical structure. The float 44 is connected to the valve lid 42. After the level of the ink stored in the ink storage chamber 26 rises above a specific height, the float 44 may move with the valve lid 42 along the vent channel 34 by buoyant force generated from the ink, so as to expose the ink storage chamber 26 to the external pressure via the hole 40 of the upper lid 36. Furthermore, the shape of the vent channel 34 corresponds to the shape of the float 44, so as to make the air valve 38 perform rectilinear motion substantially in the vent channel 34 and the upper lid 36. The structural design of the valve lid 42 and the float 44 may be not limited to the said design shown in FIG. 5, meaning that the valve lid 42 and the float 44 may take on other common structures, and the structure of the vent channel 34 may also be changed correspondingly. For example, the valve lid 42 may also be a square plate.

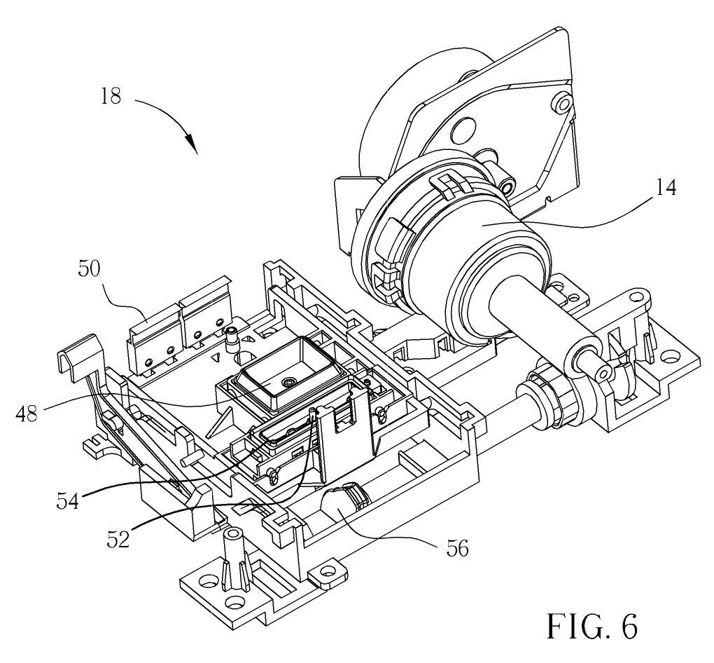

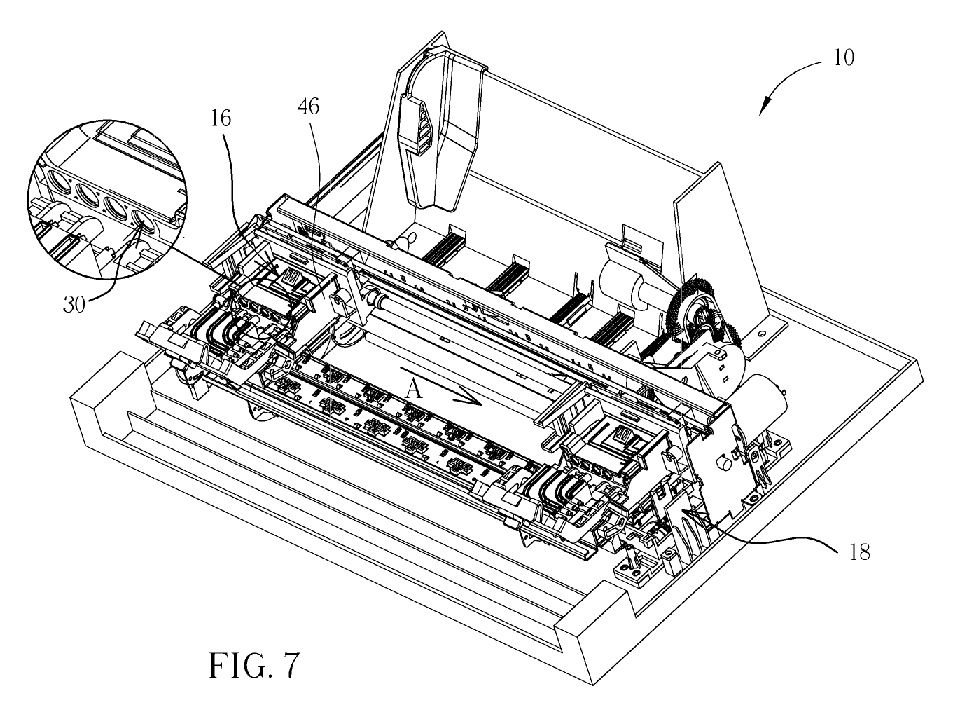

Please refer to FIG. 6. FIG. 6 is a schematic diagram of the maintenance module 18 in FIG. 1. The maintenance module 18 comprises a movable holder 46 (shown in FIG. 7), a first cap 48, an ink scraping part 50, a second cap 52, a linkage rod 54, and a cam 56. The first cap 48 is used for covering the print head 24 to prevent ink on the print head 24 from drying out, or may prevent dust. The ink scraping part 50 is disposed at a side of the first cap 48 for scraping away remnant ink from the print head 24. The second cap 52 is used for connecting the air chamber 22 of the ink storage module 16 to the air-extracting device 14. The linkage rod 54 is disposed in the second cap 52. The cam 56 is connected to the linkage rod 54 for driving the linkage rod 54 to control access between the air chamber 22 and the air-extracting device 14 when the second cap 52 connects the air chamber 22 and the air-extracting device 14.

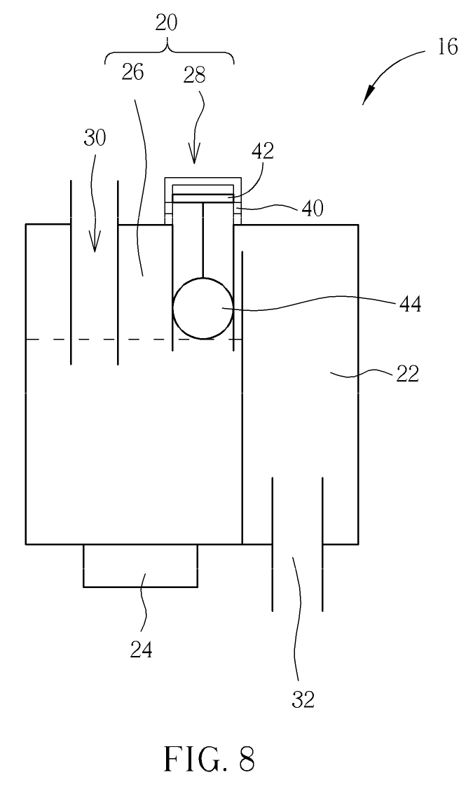

The description for the printing system 10 is provided as follows. Please refer to FIG. 7. FIG. 7 is a diagram of internal structure of the printing system 10 in FIG. 1. When the printing system 10 starts to perform an initial ink filling procedure, the printing system 10 may drive the movable holder 46 to take the ink storage module 16 in a direction indicated by an arrow “A” in FIG. 7 to the maintenance module 18. After the print head 24 of the ink storage module 16 and the air chamber 22 arrive at the locations of the first cap 48 and the second cap 52, respectively, the ink storage chamber 26 is cut off from the external pressure, since the air valve 38 is located at the location shown in FIG. 3. Subsequently, the printing system 10 may drive the cam 56 of the maintenance module 18 to make the linkage rod 54 move upward, so as to open the air chamber 22 to the air-extracting device 14 via the air outlet 32. Thus, the air-extracting device 14 may drive the ink stored in the ink tank 12 to flow from the ink tank 12 to the ink flow control device 20 via the ink inlet 30 by means of exhausting the air in the air chamber 22. When the air-extracting device 14 continues extracting the air in the air chamber 22, the ink is conveyed from the ink tank 12 to the ink storage chamber 26 continuously, so that the liquid surface of the ink stored in the ink storage chamber 26 may keep rising, since the pressure in the ink storage chamber 26 is less than the pressure in the ink tank 12. When the liquid surface of the ink is in contact with the float 44 of the air valve 38, the ink may exert a buoyant force on the float 44 because the density of the float 44 is less than that of the ink. After the buoyant force that the ink exerts on the float 44 overcomes the frictional force that the upper lid 36 exerts on the valve lid 42 (since the valve lid 42 and the upper lid 36 are fit), the resultant force that the upper lid 36 exerts on the valve lid 42 and the buoyant force that the ink exerts on the float 44 may move the valve lid 42 from the location in FIG. 3 to the location in FIG. 8. In such a manner, as shown in FIG. 8, the ink storage chamber 26 is exposed to the external pressure via the hole 40 to stop the ink from conveying from the ink tank 12 to the ink storage chamber 26, thereby finishing the ink filling procedure of the printing system 10.

Finally, the printing system 10 may convey the ink stored in the ink storage chamber 26 into the print head 24 located under the ink storage chamber 26 for performing the subsequent printing procedures. It should be mentioned that the ink tank 12 may keep conveying the stored ink into the ink storage chamber 26 due to the negative pressure generated by the print head 24 when the ink is jetting from the print head 24.

In summary, when the printing system 10 is going to resupply ink to the ink storage chamber 26 of each ink flow control device 20 in the ink storage module 16, the printing system 10 may convey ink stored in each ink tank 12 to the corresponding ink storage chamber 26, respectively, by means of the air-extracting device 14 extracting the air from the air chamber 22. At this time, the ink flow control device 20 may selectively determine whether each ink storage chamber 26 is exposed to the external pressure or not for controlling flow of ink in each ink storage chamber 26. For example, when the ink storage chamber 26 for storing red ink is filled up, meaning that the air valve 38 of the pressure control mechanism 28 has been moved to the location in FIG. 8, the ink tank 12 storing red ink may not convey red ink to the ink storage chamber 26 for storing red ink since the said ink storage chamber 26 has been exposed to the external pressure via the hole 40 of the upper lid 36. Instead, the other ink tanks 12 may continue conveying ink to the corresponding ink storage chamber 26 since the corresponding ink storage chamber 26 has not been exposed to the external pressure yet. Thus, the printing system 10 may achieve the objective of independently supplying ink of different colors via each ink flow control device 20 in the ink storage module 16.

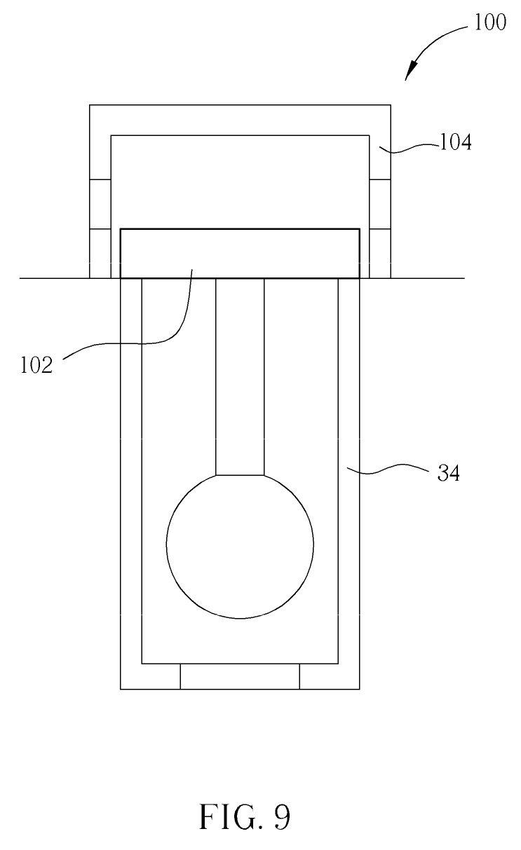

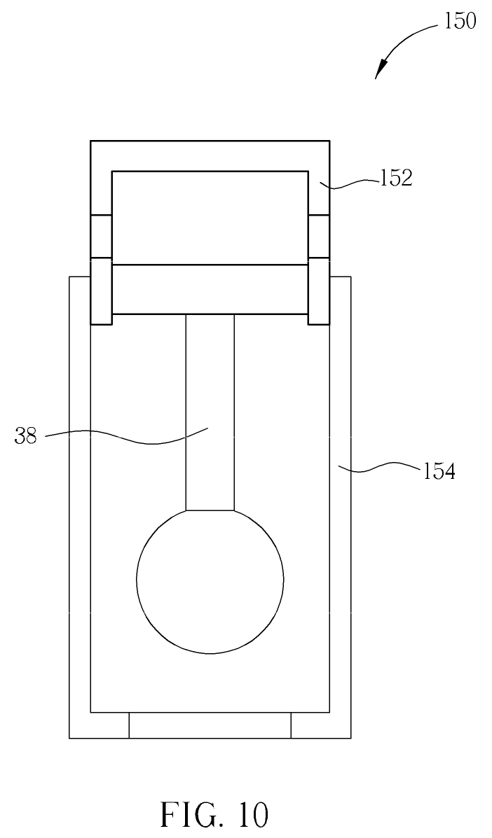

It should be noted that the structural design of the pressure control mechanism 28 is not limited to the said design. For example, please refer to FIG. 9 and FIG. 10. FIG. 9 is a diagram of a pressure control mechanism 100 according to another embodiment of the present invention. FIG. 10 is a diagram of a pressure control mechanism 150 according to another embodiment of the present invention. As shown in FIG. 9, the structural design of the air valve 38 may be changed from the design of the valve lid 42 tightly fitted to the upper lid 36 shown in FIG. 5 to a design of a valve lid 102 covering the vent channel 34 shown in FIG. 9, and the size of an upper lid 104 may also be enlarged correspondingly. In addition, as shown in FIG. 10, the connection of the upper lid 36 and the vent channel 34 may be changed from the said design shown in FIG. 4 to a design of an upper lid 152 tightly fitted to a vent channel 154 shown in FIG. 10. Furthermore, in different embodiments of the present invention, the ink storage chamber 26 may be exposed to the external pressure after the air valve 38 is moved a distance (as shown in FIG. 4) or when the air valve 38 is moved to a specific height (as shown in FIG. 9).

As mentioned above, the printing system of the present invention utilizes the said valve design in the ink storage module to control flow of ink. In addition, the loading of the movable holder may also be reduced. As a result, the motor may control the travelling distance of the movable holder more precisely. Furthermore, the printing system of the present invention may resolve the said ink leaking problem via the design of the ink flow control device, which occurs when the large volume ink storage chamber is utilized.

Those skilled in the art will readily observe that numerous modifications and alterations of the device and method may be made while retaining the teachings of the invention.

What is claimed is:

1. An ink storage module capable of controlling flow of ink to an ink tank and an air-extracting device, the ink storage module comprising:
an ink flow control device comprising:
an ink storage chamber connected to the ink tank via an ink inlet, the ink storage chamber used for receiving and storing ink conveyed from the ink tank through the ink inlet; and
a pressure control mechanism connected to the ink storage chamber for controlling the connection of an external pressure to the ink storage chamber; and
an air chamber disposed at a side of the ink flow control device and accessible to the ink storage chamber for exhausting air extracted by the air-extracting device, the air-extracting device driving ink to flow from the ink tank to the ink storage chamber when the pressure control mechanism controls the ink storage chamber to cut off the external pressure.

2. The ink storage module of claim 1, wherein the pressure control mechanism comprises:
a vent channel;
an upper lid connected to the vent channel to form an inner space, the upper lid having a hole; and
an air valve disposed in the inner space in a movable manner;
wherein the ink storage chamber cuts off the external pressure when the air valve is located at a first location, and the ink storage chamber allows the external pressure when the air valve is located at a second location.

3. The ink storage module of claim 2, wherein the air valve comprises:
a valve lid for isolating the ink storage chamber from the external pressure; and
a float connected to the valve lid for driving the valve lid to move to the second location to connect the external pressure to the ink storage chamber via the hole when level of the ink stored in the ink storage chamber is greater than a specific value.

4. The ink storage module of claim 3, wherein the shape of the vent channel corresponds to the shape of the float for the air valve to perform rectilinear motion substantially in the inner space.

5. The ink storage module of claim 3, wherein the valve lid is made of rubber material.

6. The ink storage module of claim 3, wherein the valve lid is a round plate.

7. The ink storage module of claim 3, wherein the size of the upper lid is slightly greater than the size of the valve lid, and the valve lid is used for sealing the vent channel.

8. The ink storage module of claim 3, wherein the upper lid and the valve lid of the air valve are fit tightly.

9. The ink storage module of claim 3, wherein the resultant of the frictional force exerted by the upper lid on the valve lid and the buoyant force exerted by the ink on the float moves the valve lid from the first location to the second location.

10. The ink storage module of claim 1, wherein number of the ink flow control device is plural, and the ink storage chamber of each ink flow control device is accessible to the air chamber respectively.

11. A printing system capable of controlling flow of ink, the printing system comprising:
an ink tank;
an air-extracting device for driving ink stored in the ink tank; and
an ink storage module connected to the ink tank and the air-extracting device, the ink storage module comprising:
an ink flow control device comprising:
an ink storage chamber connected to the ink tank via an ink inlet, the ink storage chamber used for receiving and storing the ink conveyed from the ink tank through the ink inlet; and
a pressure control mechanism connected to the ink storage chamber for controlling the connection of an external pressure to the ink storage chamber; and
an air chamber disposed at a side of the ink flow control device and accessible to the ink storage chamber for exhausting air extracted by the air-extracting device, the air-extracting device driving ink to flow from the ink tank to the ink storage chamber when the pressure control mechanism controls the ink storage chamber to cut off the external pressure.

12. The printing system of claim 11, wherein the pressure control mechanism comprises:
a vent channel;
an upper lid connected to the vent channel to form an inner space, the upper lid having a hole; and
an air valve disposed in the inner space in a movable manner;
wherein the ink storage chamber cuts off the external pressure when the air valve is located at a first location, and the ink storage chamber allows the external pressure when the air valve is located at a second location.

13. The printing system of claim 12, wherein the air valve comprises:
a valve lid for isolating the ink storage chamber from the external pressure when the valve lid is located at the first location; and
a float connected to the valve lid for driving the valve lid to move to the second location to connect the external pressure to the ink storage chamber via the hole when level of the ink stored in the ink storage chamber is greater than a specific value.

14. The printing system of claim 13, wherein the shape of the vent channel corresponds to the shape of the float for the air valve to perform rectilinear motion substantially in the inner space.

15. The printing system of claim 13, wherein the valve lid is a round plate.

16. The printing system of claim 13, wherein the size of the upper lid is slightly greater than the size of the valve lid, and the valve lid is used for sealing the vent channel.

17. The printing system of claim 13, wherein the resultant of the frictional force exerted by the upper lid on the valve lid and the buoyant force exerted by the ink on the float moves the valve lid from the first location to the second location.

18. The printing system of claim 13, wherein the upper lid and the valve lid of the air valve are fit tightly for isolating the ink storage chamber from the external pressure.

19. The printing system of claim 11, wherein the air chamber has an air outlet for exhausting the air extracted from the air chamber via the air-extracting device.

20. The printing system of claim 11, wherein number of the ink flow control device is plural, and the ink storage chamber of each ink flow control device is accessible to the air chamber respectively.
